(19) United States
(12) Patent Application Publication
(10) Pub. No.: US 2016/0107418 A1
(43) Pub. Date: Apr. 21, 2016

(54) STONE SHEET MADE OF REAL STONE FOR AN AUTOMOBILE INTERIOR MATERIAL AND METHOD OF MANUFACTURING

(71) Applicant: Hyundai Motor Company, Soul (KR)

(72) Inventors: Ho Tak Jeon, Hwaseong (KR); Hyo Jin Lee, Busan (KR)

(21) Appl. No.: 14/569,649

(22) Filed: Dec. 13, 2014

(30) Foreign Application Priority Data
Oct. 16, 2014 (KR) 10-2014-0140083

(51) Int. Cl. B32B 9/00; B32B 5/02; B29D 99/00; B32B 38/00; B32B 37/02; B32B 9/04; B32B 7/12

(52) U.S. Cl. CPC B32B 9/002; B32B 9/045; B32B 5/022; B32B 7/12; B32B 38/0012; B32B 38/0004; B32B 37/02; B29D 99/0021; B32B 2255/26; B32B 2250/02; B32B 2605/003; B32B 2605/08; B32B 2305/20; B32B 2262/0261; B32B 2262/0284; B32B 2038/0016; B29K 2075/00

(57) ABSTRACT

A stone sheet made of a natural stone for automotive interior material, and a method of manufacturing are provided. The stone sheet made of a natural stone material includes a thin-film stone and an adhesive applied to a side of the thin-film stone. In addition, a reinforcing member is attached to the thin-film stone by the adhesive. The stone sheet satisfies demands of customers in the automobile industry. In addition, since an automotive interior material made of a natural material is provided, quality is improved and a vehicle using the interior material is more environmentally friendly.

### CROSS-REFERENCE TO RELATED APPLICATION(S)

This application claims under 35 U.S.C. §119(a) the benefit of Korean Patent Application No. 10-2014-0140083 filed Oct. 16, 2014, the entire contents of which are incorporated herein by reference.

### BACKGROUND

1. Technical Field

The present disclosure relates to a stone sheet made of a natural stone for an automotive interior material and a method of manufacturing the material, and more particularly, to a stone sheet that satisfies consumer demands for an automotive interior material, achieves improved quality, and uses a natural stone.

2. Background Art

Recently, vehicle manufacturers have produced vehicles that have substantially similar performance. Accordingly, customers have more interest in design-related elements of vehicles. However, the exterior appearance of vehicles may not vary substantially, except the color of the vehicle, so different automotive interior materials may need to be produced.

Accordingly, although automotive interior material that uses natural woods has been developed, consumer demands may not be fully satisfied. A method of manufacturing an automotive interior material using natural stone material that may have various surface patterns has been developed. A natural stone composite panel has been proposed in the related art, but according to this idea, a marble is cut into thin sheets with a predetermined thickness by a saw, so the manufacturing method may not be efficient and economical. Further, a metal sheet is inserted to increase strength of a panel, so free forming may be difficult and may not be suitable for an automotive interior material.

The above information disclosed in this section is merely for enhancement of understanding of the background of the invention and therefore it may include information that does not form the prior art that is already known in this country to a person of ordinary skill in the art.

### SUMMARY

The present invention provides a stone sheet made of a natural stone that may have various surface patterns for an automotive interior material and a method of manufacturing the material. The present invention also provides a stone sheet, which is made to be substantially soft by forming a natural stone in a thin sheet so the stone sheet may be formed into a shape for an automotive interior material without breaking and to which a reinforcing member (e.g., reinforcing sheet) may be attached to resist pressure applied to the natural stone in processes such as pressing, and a method of manufacturing the stone sheet.

In one aspect, a stone sheet made of a natural material may include a thin-film stone, an adhesive applied to one side (e.g., a first side) of the thin-film stone, and a reinforcing member attached to the thin-film stone by the adhesive. The thickness of the stone sheet may be about 0.2 millimeters (mm) to about 2.5 mm. Further, the thin-film stone may be argillite or quartzite. The adhesive may have a non-yellowing property (e.g., does not turn yellow).

The reinforcing member may be a non-woven fabric. Further, the reinforcing member may be a long fiber non-woven fabric manufactured by a spunbond type or spunlace type. The reinforcing member may also be a bicomponent non-woven fabric that includes polyethylene terephthalate and nylon.

In another aspect, the present invention provides a method of manufacturing a stone sheet made of a natural stone that may include: applying an adhesive onto one side (e.g., a first side) of a natural stone; placing, pressing, and drying a reinforcing member on the side with the adhesive applied; cutting off the thin-film stone with the reinforcing member attached, from the natural stone; and grinding the thin-film stone. The present invention also provides an automotive interior material that uses a stone sheet made of a natural stone that may include a stone sheet, an injection-molding material injection-molded on one side (e.g., a first side) of the stone sheet, and a coating layer formed on the other side (e.g., a second side) of the stone sheet.

The stone sheet may be formed into a shape of an automotive interior material before the injection-molding material or the coating layer is formed. Further, the coating layer may be a thick-film polyurethane coating layer. In addition, the thickness of the coating layer may be about 0.6 mm to about 0.8 mm. Furthermore, the coating layer may be a thin-film coating layer formed by painting. In particular, the coating layer may be formed by color painting or clear painting.

In a further aspect, the present invention provides a method of manufacturing an automotive interior material using a stone sheet made of a natural stone that may include: pressing a stone sheet into a shape of an automotive interior material; inserting the stone sheet into a mold and injection-molding an injection-molding material on one side (e.g., a first side) of the stone sheet; and forming a coating layer on the other side (e.g., a second side) of the stone sheet by injecting polyol and isocyanate into the mold. In addition, the present invention provides a method of manufacturing an automotive interior material using a stone sheet made of a natural stone that may include: pressing a stone sheet into the shape of an automotive interior material; inserting the stone sheet into a mold and injection-molding an injection-molding material on one side of the stone sheet; and forming a coating layer on another side of the stone sheet by painting the other side.

According to the stone sheet made of a natural stone for an automotive interior material, and a method of manufacturing the stone sheet may satisfy demands of customers in the automobile industry. Since an automotive interior material made of a natural material is provided, quality may be improved and a vehicle using the interior material may be more environmentally friendly. Further, since a natural stone has not previously been used for an automotive interior material, a new surface treatment pattern for automotive interior materials may be used.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is an exemplary diagram schematically illustrating the cross-sectional structure of a stone sheet made of a natural stone according to an exemplary embodiment of the present invention;

FIG. 2 is an exemplary diagram schematically illustrating the components of an automotive interior material using the stone sheet made of a natural stone according to an exemplary embodiment of the present invention; and

FIG. 3 is an exemplary image illustrating pre-forming of a stone sheet.

Reference numerals set forth in the Drawings includes reference to the following elements as further discussed below:
1: stone sheet
3: injection-molding material
5: coating layer
11: thin-film stone
13: adhesive
15: reinforcing member

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other exemplary embodiments, which may be included within the spirit and scope of the invention as defined by the appended claims.

The following examples illustrate the invention and are not intended to limit the same.

Hereinafter, the present invention will be described more fully with reference to the accompanying drawings for those skilled in the art to easily implement the present invention.

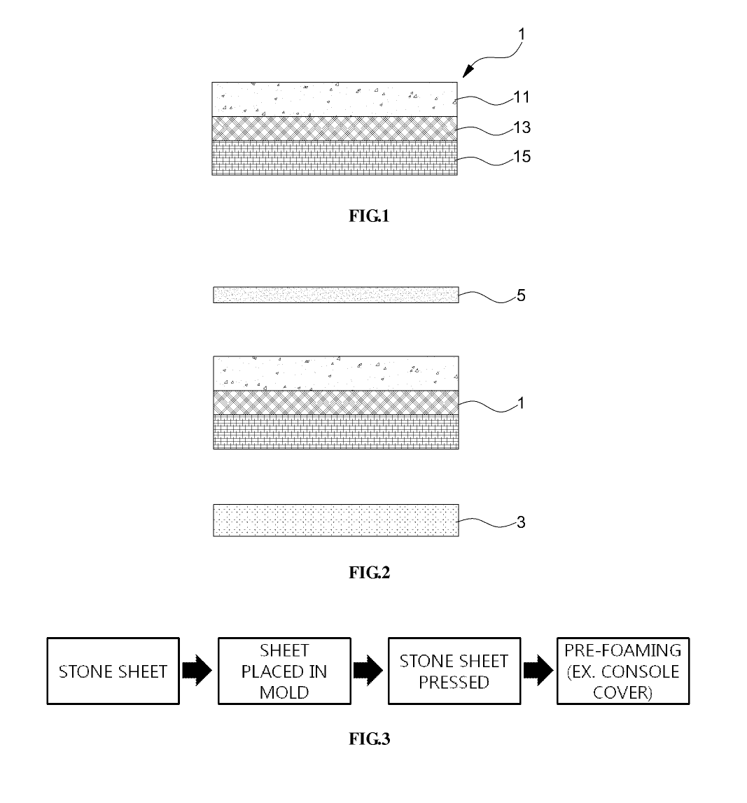

Referring to FIG. 1, a stone sheet 1 made of a natural stone according to an exemplary embodiment of the present invention may include a thin-film stone 11, an adhesive 13 applied to one side (e.g., a first side) of the thin-film stone 11, and a reinforcing member (e.g., reinforcing sheet) 15 attached to the thin-film stone 11 by the adhesive 13. The thin-film stone 11, may be cut in a shape of a thin plate, may have a natural surface pattern of a natural stone, and thus may provide a natural surface pattern for an automotive surface pattern. The thin-film stone 11 may be cut, in the shape of a plate, from a natural stone. The natural stone may be metamorphic rocks that may be cleaved due to excellent foliation (e.g., argillite or quartzite). In accordance with a manufacturing method, the thin-film stone 11 cut in the shape of a plate may have a thickness of about 0.1 millimeters (mm) to about 2.4 mm after grinding.

The adhesive 13 may be configured to ensure an interlayer adhesive force and formability (e.g., shapeable) of the components of the stone sheet 1 in a method of manufacturing an automotive interior material using the stone sheet 1 to be described below. The adhesive 13 may be a poly vinyl acetate-based adhesive since the poly vinyl acetate-based adhesive has a non-yellowing property at greater than about 120° C. The term ‘non-yellowing’ means that the adhesive 13 does not change in color, when high-temperature heat is continuously applied to the adhesive 13. Accordingly, since the adhesive 13 has a non-yellowing property, the adhesive may not change in color when used for an automotive interior material, so the specific pattern of the thin-film stone 11 may be fully exhibited on an automotive interior material.

The reinforcing member 15, which may be attached to the thin-film stone 11 by the adhesive 13, may make the stone sheet 1 strong enough to resist pressure applied to the stone sheet 1 during press forming and injection-molding pressure of an injection-molding material 3 in the method of manufacturing an automotive interior material using the stone sheet 1 to be described below. Further, the reinforcing member may be configured to improve the ability of the stone sheet to be attached to the injection-molding material 3. The reinforcing member 15 may be a knitted material or a non-woven fabric. In particular, the reinforcing member 15 may be a non-woven fabric that may be well bonded to the thin-film stone 11 and well attached to the injection-holding member 3 and has excellent formability relative to the knit material.

Further, the non-woven fabric may be a long fiber non-woven fabric with substantially long fibers that are a base of the fabric that has a greater interlayer adhesive force relative to a short fiber non-woven fabric. In addition, a long fiber non-woven fabric made in a spunlace type that forms a web by pressing fibers by spraying high-pressure water, a spunbond type that forms a web by directly melting, spraying, and pressing fibers, or a long fiber non-woven fiber made in the spunlace type which has improved adhesive force without the adhesive 13 may be used.

When a monocomponent fabric of polyethylene terephthalate (hereafter, referred to as PET) is used for the non-woven fabric, heat resistance and formability may be insufficient, thus a bicomponent fiber composed of PET and nylon may be used. The non-woven fabric may weigh at least about 100 grams (g) to ensure rigidity that may resist pressure applied in press forming and injection-molding pressure. The stone sheet may be used to manufacture an automotive interior material to be described below, but is not limited thereto and may be used for various products that are formed in predetermined shapes such as an interior product, a household electric appliance, a case for a mobile phone, and an interior/facing material for construction.

A method of manufacturing the stone sheet 1 may include applying the adhesive 13 onto the natural stone; placing, pressing, and drying the reinforcing member 15 on the side with the adhesive 13 applied; cutting the thin-film stone 11 with the reinforcing member 15 attached, from the natural stone; and grinding the thin-film stone 11. The stone sheet 1 that includes the components illustrated in FIG. 1 may be manufactured by applying the adhesive 13 onto the natural stone; placing, pressing, and drying the reinforcing member 15 on the side with the adhesive 13 applied; and cutting the thin-film stone 11 with the reinforcing member 15 attached, from the natural stone.

The reinforcing member 15 may not be attached after the thin-film stone 11 is cut from the natural stone, but the reinforcing member 15 may be attached to the natural stone by the adhesive 13 and the thin-film stone 11 may be cut with the reinforcing member 15 is attached from the natural stone. Accordingly, since the reinforcing member 15 provides rigidity in the process of cutting the thin-film stone 11, the thin-film stone 11 may not break, thus creating a more convenient process and a natural stone may be formed into thin plates.

The grinding of the thin-film stone may adjust the thickness of the stone sheet 1 to a range of about 0.2 mm to about 2.5 mm by grinding a side of the stone sheet 1. In addition, the adhesive force between the stone sheet 1 and a coating layer 5 may be improved. Since the stone sheet 1 includes the thin-film stone 11 that exhibits the surface of the natural stone, various surface treatments may be possible. Further, since the stone sheet that includes the reinforcing member 15, the thin-film stone 11 may be more easily cut from the natural stone and the fragility of a natural stone may be strengthened, thus free forming may be possible.

Referring to FIG. 2, an automotive interior material that uses the stone sheet 1 according to the present invention may include a stone sheet 1, an injection-molding material 3 injection-molded on one side (e.g., a first side) of the stone sheet 1, and a coating layer 5 formed on the other side (e.g., a second side) of the stone sheet 1. The stone sheet 1 may include a thin-film stone 11, an adhesive 13, and a reinforcing member 15, as described above. In addition, the stone sheet may undergo pre-forming, which means, as described below, that the stone sheet 1 is formed in a predetermined shape of an automotive interior material by press forming in a mold, before the injection-molding material 3 is formed on a side of the stone sheet 1. The injection-molding material 3 may be formed by injecting a material on a side of the stone sheet 1 that is inserted into a mold that has a predetermined shape. Accordingly, since the automotive interior material the stone sheet 1 on the injection-molding material 3, the surface pattern of the thin-film stone 11 may be exhibited externally, unlike the related art.

The coating layer 5 may be formed on the other side of the stone sheet 1 by thick-film coating or thin-film coating. Thick-film coating may provide a feeling of depth of a natural stone to the automotive interior material by forming a thick coating layer 5 (e.g., thick-film layer) that has a thickness of about 0.6 mm to about 0.8 mm. Alternatively thin-film coating may provide the natural stone feeling of the stone sheet 1 by forming a thin coating layer 5 (e.g., thin-film layer) in comparison to the thick coating layer 5 formed by thick-film coating by painting. Further, the coating layer 5 formed by thick-film coating may have a substantially large thickness and the depth from the surface of the automotive interior material. In other words, the surface pattern of the natural stone of the stone sheet 1 may be substantially smoothly exhibited with solidity to the exterior, which may improve the feeling of depth.

In the thick-film coating, the stone sheet 1 may be inserted into a mold and polyol and isocyanate may be injected into the mold, which forms the polyurethane coating layer 5. Further, the coating layer 5 formed by the thin-film coating may have a minimal thickness, to preserve the surface feeling of the stone sheet 1. The coating layer 5 may be formed by color painting or clear painting, which sprays an acryl urethane type of paint on one side of the stone sheet 1. The color painting may be used to add another color to the color of the stone sheet 1 and the clear painting may be used to improve properties of the stone sheet 1 such as light resistance, wear resistance, scratch resistance, and chemical resistance. For example, the coating layer 5 may be formed using a process of color painting, drying, clear painting, drying, grinding, clear painting, and drying, or may be formed by any one of the color painting and the clear painting.

A method of manufacturing the automotive interior material may include: pressing the stone sheet 1 into the shape of an automotive interior material; inserting the stone sheet 1 into a mold and injection-molding the injection-molding material 3 on one side (e.g., a first side) of the stone sheet 1; and forming the coating layer 5 on the other side (e.g., a second side) of the stone sheet 1 by injecting polyol and isocyanate into the mold.

Referring to FIG. 3, the pressing of the stone sheet 1 into the shape of an automotive interior material may be to pre-form the stone sheet 1 by placing the stone sheet 1 into a mold and then pressing it into a desired shape of automotive interior material. Accordingly, an automotive interior material having a predetermined shape may be manufactured by applying the injection-molding material 3 and the coating layer 5 to the pre-foamed stone sheet 1.

The manufacturing method may be a method of manufacturing an automotive interior material that includes the coating layer 5 formed by thick-film coating. A method of manufacturing an automotive interior material may include the coating layer 5 formed by thin-film coating may include: pressing the stone sheet 1 into the shape of an automotive interior material; inserting the stone sheet 1 into a mold and injection-molding the injection-molding material on a side of the stone sheet 1; and forming the coating layer 5 on the other side of the stone sheet 1 by painting.

The automotive interior material according to the present invention may be a decoration for an interior of a vehicle such as a console, a center fascia, and a garnish. Since the automotive interior material that uses the stone sheet 1 made of a natural stone according to the present invention may maintain the surface pattern of the natural stone, to obtain various surface patterns. Accordingly, various demands of customers may be satisfied and a vehicle may be made more environmentally friendly. Further, a next-generation surface treatment pattern for automotive interior materials may be created.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A stone sheet made of a natural stone material, comprising:
a thin-film stone;
an adhesive applied to a first side of the thin-film stone; and
a reinforcing member attached to the thin-film stone by the adhesive.

2. The stone sheet of claim 1, wherein the thickness of the stone sheet is about 0.2 millimeters (mm) to about 2.5 mm.

3. The stone sheet of claim 1, wherein the thin-film stone is argillite or quartzite.

4. The stone sheet of claim 1, wherein the adhesive has a non-yellowing property.

5. The stone sheet of claim 1, wherein the reinforcing member is a non-woven fabric.

6. The stone sheet of claim 5, wherein the reinforcing member is a long fiber non-woven fabric.

7. The stone sheet of claim 6, wherein the reinforcing member is a non-woven fabric manufactured by a spunbond type or spunlace type.

8. The stone sheet of claim 6, wherein the reinforcing member is a bicomponent non-woven fabric including polyethylene terephthalate and nylon.

9. A method of manufacturing a stone sheet made of a natural stone, comprising:
applying an adhesive onto a natural stone;
placing, pressing, and drying a reinforcing member on the adhesive;
cutting a thin-film stone with the reinforcing member attached, from the natural stone; and
grinding the thin-film stone.

10. An automotive interior material using a stone sheet made of a natural stone, the automotive interior material comprising:
a stone sheet;
an injection-molding material injection-molded on a first side of the stone sheet; and
a coating layer formed on a second side of the stone sheet opposite of the injection-molding material.

11. The automotive interior material of claim 10, wherein the stone sheet is formed into the shape of the automotive interior material before the injection-molding material or the coating layer is formed.

12. The automotive interior material of claim 10, wherein the coating layer is a thick-film polyurethane coating layer.

13. The automotive interior material of claim 12, wherein the thickness of the coating layer is about 0.6 mm to about 0.8 mm.

14. The automotive interior material of claim 10, wherein the coating layer is a thin-film coating layer formed by painting.

15. The automotive interior material of claim 14, wherein the coating layer is formed by color painting or clear painting.

16. A method of manufacturing an automotive interior material using a stone sheet made of a natural stone, the method comprising:
pressing a stone sheet into the shape of an automotive interior material;
inserting the stone sheet into a mold and injection-molding an injection-molding material on a first side of the stone sheet; and
forming a coating layer on a second side of the stone sheet opposite of the injection molding material by injecting polyol and isocyanate into the mold.

17. The method of claim 16, wherein the thickness of the coating layer is about 0.6 millimeters to about 0.8 mm.

18. A method of manufacturing an automotive interior material using a stone sheet made of a natural stone, the method comprising:
pressing a stone sheet into the shape of an automotive interior material;
inserting the stone sheet into a mold and injection-molding an injection-molding material on a first side of the stone sheet; and
forming a coating layer on a second side of the stone sheet opposite the injection-molding material by painting the second side.

19. The method of claim 18, wherein the coating layer is formed by color painting or clear painting.
